(19) United States
(12) Patent Application Publication
(10) Pub. No.: US 2026/0313180 A1
(43) Pub. Date: Oct. 8, 2026

(54) TECHNIQUE FOR HANDLING FILTERING-RELATED INFORMATION IN A CORE NETWORK DOMAIN OF A WIRELESS COMMUNICATION NETWORK

(71) Applicant: Telefonaktiebolaget LM Ericsson (publ), Stockholm (SE)

(72) Inventors: Miguel Angel MUÑOZ DE LA TORRE ALONSO, Madrid (ES); Rodrigo ALVAREZ DOMINGUEZ, Madrid (ES)

(21) Appl. No.: 18/998,321

(22) PCT Filed: Oct. 25, 2022
(86) PCT No.: PCT/EP2022/079725

§ 371 Date: Jan. 24, 2025

(30) Foreign Application Priority Data
Jul. 28, 2022 (EP) 22382727.0

(51) Int. Cl. H04N 21/258; G06F 3/01; H04N 21/2668; H04N 21/4545

(52) U.S. Cl. CPC H04N 21/25808; G06F 3/011; H04N 21/2668; H04N 21/4545

(57) ABSTRACT

The present disclosure is directed at a technique of retrieving filtering control information from a subscriber database in a core network domain of a wireless communication network. The subscriber database stores subscription-related information. A method implementation of the present disclosure includes receiving a subscription data request, wherein the subscription data request includes an identifier associated with a subscription. The method further includes retrieving from the subscriber database in the core network domain, in response to the subscription data request, filtering control information for the subscription associated with the identifier. The filtering control information defines sensual content different from audio and video content that has been deselected for transmission towards a subscriber domain. Further still, the method includes sending a subscription data response including the filtering control information.

### TECHNICAL FIELD

The present disclosure generally relates to wireless communication. In more detail, aspects in the context of handling filtering-related information in a core network domain of a wireless communication network are presented. The filtering-related information is indicative of sensual content different from audio and video content that has been deselected for transmission towards a subscriber domain.

The aspects presented herein can be implemented as methods, computer program products, apparatuses and a system.

### BACKGROUND

The consumption of digital content including audio (A) and video (V) digital content has become increasingly popular in the last decades. With the introduction of high speed cellular communication networks of the 4^{th} (4G) and the 5^{th} (5G) Generation, digital content is today also heavily consumed via smartphones and other terminal devices that are operated on a subscription basis in a subscriber domain. The digital content originates in a content provider domain and is routed to the subscriber domain through 4G and 5G core and access network domains.

It is expected that the next decade will increasingly see the introduction of non-A/V digital content to enhance user experience, which is sometimes also referred to as the “Internet of Senses”. As an example, scent technology (also called olfactory technology) enables controlling generation of an olfactory medium and can form the basis of scent-enabled digital content such as web pages, advertisements, video games, movies and music. As a further example, tactile technology targets at output of a haptic medium when rendering haptically enabled digital content. The resulting haptic user experience can relate to the perception and manipulation of objects using touch and proprioception. Proprioception is the sense of the relative positioning of one's body parts and the strength of effort used in a movement.

To experience non-A/V digital content, also called sensual content hereinafter, a content recipient will need a generator capable of rendering tactile, scent-related or other non-A/V sensual content. A scent generator may, for example, be integrated into a television set that supports scent-enabled movies. A generator for tactile feedback can be integrated into a wearable device such as a glove.

With the widespread introduction of sensual content, content providers may wish to offer scent-enabled movies as streaming services. Other sensual content such as games or web pages with tactile user experience may be offered for download via the Internet.

In these and other digital content provision scenarios, content providers face various challenges. For example, content providers may not be aware of whether or not a domain of a particular content consumer is technically capable of supporting output of sensual content. Some content providers may install a proprietary application on a consumer's terminal device and exchange proprietary signalling with that application to determine capability information regarding sensual content support (e.g., to determine if a scent generator is installed). However, not all consumers may wish to install such applications, and not all content providers may have a proprietary application.

Another solution for implementing the Internet of Senses and similar sensual content services is the use of different uniform resource identifiers (URIs) for content access, depending on whether or not a given Web browser or other Internet-enabled application in the domain of a content consumer is capable of supporting sensual content (e.g., http://internetofsense/app.html vs. http://app.html). One drawback of such an approach results from the fact that it may be difficult to duplicate or tag the URIs differently depending on the type of access (e.g., mobile vs. non-mobile access, etc.), which may be desirable to enhance user experience, or for other purposes.

The transmission of sensual content consumes bandwidth, which is a particular challenge in case of a large number of parallel streaming sessions via inherently bandwidth-limited wireless connections. It would generally be desirable to enhance control of sensual content transmission, without a consumer having to necessarily configure a corresponding personal profile for each of multiple different content providers.

### SUMMARY

There is a need for a technique that avoids one more of the above or other drawbacks, and that enables an efficient control of sensual content transmission.

A first aspect is directed at a method of retrieving filtering control information from a subscriber database in a core network domain of a wireless communication network, wherein the subscriber database stores subscription-related information. The method comprises receiving a subscription data request, wherein the subscription data request includes an identifier associated with a subscription. The method further comprises retrieving from the subscriber database in the core network domain, in response to the subscription data request, filtering control information for the subscription associated with the identifier, wherein the filtering control information is indicative of sensual content different from audio and video content that has been deselected for transmission towards a subscriber domain. Further still, the method comprises sending a subscription data response including the filtering control information.

A second aspect is directed at a method of filtering user plane traffic in a core network domain of a wireless communication network. The method comprises receiving filtering control information indicative of sensual content different from audio and video content that has been deselected for transmission towards a subscriber domain. The method further comprises detecting user plane traffic that requires sensual content filtering, wherein the user plane traffic originates in a content provider domain and is directed towards the subscriber domain. The method also comprises applying the filtering control information to the detected user plane traffic so as to filter out the deselected sensual content.

A third aspect is directed at a method of filtering digital content in a content provider domain. The method comprises receiving, from a core network domain of a wireless communication network, filtering control information indicative of sensual content different from audio and video content that has been deselected for transmission towards a subscriber domain. The method comprises receiving, via the core network domain, a digital content request originating in the subscriber domain, and applying the filtering control information to filter out the deselected sensual content from digital content that is to be transmitted responsive to the digital content request.

A fourth aspect is directed at a method of providing filtering control information to a subscriber database in a core network domain of a wireless communication network. The method comprises the following steps performed in a subscriber domain: defining filtering control information for a subscription associated with an identifier in the subscriber database, wherein the filtering control information is indicative of sensual content different from audio and video content that is deselected for transmission towards the subscriber domain; and triggering storage of the filtering control information in the subscriber database.

A fifth aspect is directed at a method of providing filtering policy information to a core network domain of a wireless communication network. The method comprises the following steps performed in a content provider domain, the steps including defining filtering policy information, wherein the filtering policy information is indicative of first sensual content different from audio and video content that is deselected for transmission towards a subscriber domain in a context of second sensual content different from audio and video content that is provided from the content provider domain. The steps further include triggering storage of the filtering policy information in the core network domain.

A sixth aspect is directed at a method of filtering user plane traffic in a core network domain of a wireless communication network. The method comprises receiving filtering policy information indicative of first sensual content different from audio and video content that is deselected for trans-mission towards a subscriber domain in a context of second sensual content different from audio and video content that is provided from the content provider domain. The method further comprise detecting user plane traffic that requires sensual content filtering and applying the filtering policy information to the detected user plane traffic so as to filter out the deselected first sensual content in the context of the second sensual content.

Also provided is a computer program product comprising program code portions for performing the steps of any of the method aspects presented herein when the computer program product is executed on one or more processors. The computer program product may be stored on a computer readable recording medium.

A further aspect is directed at an apparatus for retrieving filtering control information from a subscriber database in a core network domain of a wireless communication network. The subscriber database stores subscription-related information. The apparatus is configured to receive a subscription data request, wherein the subscription data request includes an identifier associated with a subscription. The apparatus is further configured to retrieve from the subscriber database in the core network domain, in response to the subscription data request, filtering control information for the subscription associated with the identifier, wherein the filtering control information is indicative of sensual content different from audio and video content that has been deselected for transmission towards a subscriber domain. The apparatus is further configured to send a subscription data response including the filtering control information.

Another aspect is directed at a first apparatus for filtering user plane traffic in a core network domain of a wireless communication network. The apparatus is configured to receive filtering control information indicative of sensual content different from audio and video content that has been deselected for transmission towards a subscriber domain. The apparatus is further configured to detect user plane traffic that requires sensual content filtering, wherein the user plane traffic originates in a content provider domain and is directed towards the subscriber domain. The apparatus is also configured to apply the filtering control information to the detected user plane traffic so as to filter out the deselected sensual content.

A still further aspect is directed at an apparatus for filtering digital content in a content provider domain. The apparatus is configured to receive, from a core network domain of a wireless communication network, filtering control information indicative of sensual content different from audio and video content that has been deselected for transmission towards a subscriber domain. The apparatus is further configured to receive, via the core network domain, a digital content request originating in the subscriber domain. The apparatus is further configured to apply the filtering control information to filter out the deselected sensual content from digital content that is to be transmitted responsive to the digital content request.

Moreover, a further aspect is directed at an apparatus for providing filtering control information to a subscriber database in a core network domain of a wireless communication network. The apparatus is configured to define filtering control information for a subscription associated with an identifier in the subscriber database, wherein the filtering control information is indicative of sensual content different from audio and video content that is deselected for transmission towards a subscriber domain. The apparatus is further configured to trigger storage of the filtering control information in the subscriber database.

A still further aspect is directed at an apparatus for providing filtering policy information from a content provider domain to a core network domain of a wireless communication network. The apparatus is configured to define filtering policy information, wherein the filtering policy information is indicative of first sensual content different from audio and video content that is deselected for transmission towards a subscriber domain in a context of second sensual content different from audio and video content that is provided from the content provider domain. The apparatus is further configured to trigger storage of the filtering policy information in the core network domain.

Another aspect is directed at a second apparatus for filtering user plane traffic in a core network domain of a wireless communication network. The apparatus is configured to receive filtering policy information indicative of first sensual content different from audio and video content that is deselected for transmission towards a subscriber domain in a context of second sensual content different from audio and video content that is provided from the content provider domain. The apparatus is further configured to detect user plane traffic that requires sensual content filtering and to apply the filtering policy information to the detected user plane traffic so as to filter out the deselected first sensual content in the context of the second sensual content.

Also provided is a system comprising two or more of:
a. the apparatus for retrieving filtering control information from a subscriber database;
b. the first apparatus for filtering user plane traffic in a core network domain;
c. the apparatus for filtering digital content in a content provider domain;
d. the apparatus for providing filtering control information from a subscriber domain to a subscriber database;
e. the apparatus for providing filtering policy information from a content provider domain to a core network domain of a wireless communication network; and
f. the second apparatus for filtering user plane traffic in a core network domain.

### BRIEF DESCRIPTION OF THE DRAWINGS

Further aspects, details and advantages of the present disclosure will become apparent from the detailed description of exemplary embodiments below and from the drawings, wherein:

FIG. 1 is a diagram illustrating a system realization of the present disclosure;

FIG. 2 is a block diagram illustrating an apparatus realization of the present disclosure;

FIGS. 3A to C are flow diagrams illustrating method realizations of the present disclosure;

FIG. 4 is a diagram illustrating an exemplary 5G network architecture that can form the basis of realizations of the present disclosure; and

FIGS. 5 to 10 are schematic signalling diagrams illustrating further realizations of the present disclosure based on the 5G network architecture of FIG. 4.

### DETAILED DESCRIPTION

In the following description, for purposes of explanation and not limitation, specific details are set forth in order to provide a thorough understanding of the present disclosure. It will be apparent to one skilled in the art that the present disclosure may be practiced in other embodiments that depart from these specific details.

While, for example, the following description focuses on an exemplary core network configuration in accordance with 4G and 5G specifications, the present disclosure is not limited in this regard. The present disclosure could, for example, also be implemented in other cellular or non-cellular wireless communication networks having a core network domain, such as those complying with beyond-5G specifications.

Those skilled in the art will further appreciate that the steps, services and functions explained herein may be implemented using individual hardware circuits, using software functioning in conjunction with a programmed processor or general purpose computer, using one or more application specific integrated circuits (ASICs) and/or using one or more digital signal processors (DSP). It will also be appreciated that when the present disclosure is described in terms of a method, it may also be embodied in one or more processors and one or more memories coupled to the one or more processors, wherein the one or more memories store one or more computer programs that control the one or more processors to perform the steps, services and functions disclosed herein when executed by one or more processors.

In the following description of exemplary realizations of the present disclosure, the same reference numerals denote the same or similar components.

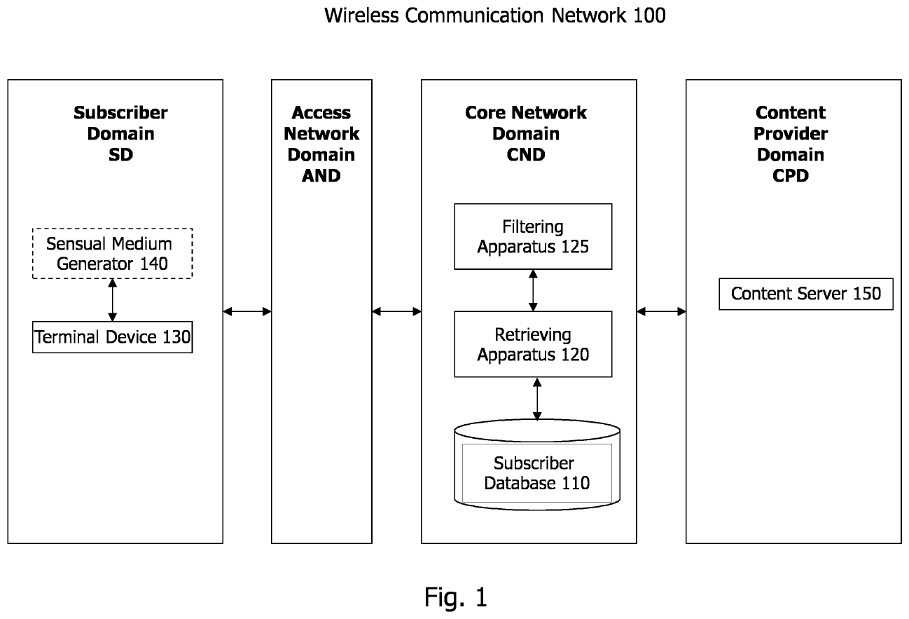

FIG. 1 illustrates an embodiment of a wireless communication network 100 in which the present disclosure can be realized. The wireless communication network 100 may be configured as a subscription-based cellular communication network operated by a mobile network operator (MNO).

As shown in FIG. 1, the wireless communication network 100 comprises a content provider domain (CPD) configured to provide digital content to a subscriber domain (SD). The network 100 further comprises a core network domain (CND) and an access network domain (AND) functionally arranged between the CPD and the SD.

In some variants, at least the CND and the AND are split into a user plane for transporting application traffic (e.g., digital content) and a control plane for transporting control signalling. As understood herein, a particular domain comprises one or more devices, nodes or functions under control of a particular domain owner, such as a subscriber, an MNO or a content provider.

The CND and the AND each comprises one or more network nodes or network functions (NFs). For example, the AND may comprise one or more access points or base stations (not shown) configured to establish one or more wireless communication links to the SD. The CND comprises, among others, a subscriber database 110. The subscriber database 110 may in some implementations be hosted by a unified data repository (UDR) of a 5G-enabled CND or by a home subscriber server (HSS) of a 4G-enabled CND. The CND further comprises a retrieving apparatus 120 configured to retrieve filtering control information from the subscriber database 110 (e.g., to read corresponding information from the subscriber database 110). The retrieving apparatus 120 may be realized by one or more network nodes or NFs. The CND further comprises a filtering apparatus 125 configured to filter user plane traffic.

The filtering apparatus 125 may likewise be realized by one or more network nodes or NFs.

The SD comprises one or more terminal devices 130 configured to wirelessly communicate with the AND under a subscription regime. Exemplary terminal devices 130 comprise a user equipment-(UE-) type device (e.g., a smartphone, tablet or television set) or an Internet of Things-(IoT-) type device (e.g., a car or a wearable device such as a head-, hand- or body-mounted device) with wireless communication capabilities towards the AND.

The SD further comprises, although not necessarily as an entity of the wireless communication network 100 as such, a sensual medium generator 140 capable of communicating with the terminal device 130 and of generating and rendering (i.e., outputting) at least one non-A/V sensual medium based on non-A/V sensual content wirelessly received via the terminal device 130.

In some implementations, the terminal device 130 and the sensual medium generator 140 are integrated into a single device, such as non-A/V sensual medium enabled television set that has wireless communication capabilities and that can render, or output, at least one non-A/V medium (e.g., scent) in addition to conventional A/V media (e.g., to support scent-enabled movies). In other variants, the sensual medium generator 140 is a stand-alone device coupled to the terminal device 130 via a cable or a short-range wireless connection (e.g., Bluetooth). In such versions, the terminal device 130, or another device coupled to the terminal device 130, may be configured to render conventional A/V media such as movies, whereas the sensual medium generator 140 may be configured to render, in a synchronized manner with A/V media output, at least one associated sensual medium. In still further versions, the sensual medium generator 140 is configured as a wearable device (e.g., as a watch, helmet, glove or suit) configured to haptically output a tactile medium and, optionally, at least one A/V medium. In such versions, the terminal device 130 may, for example, be integrated into a head mounted display (HMD) or other wearable device configured to render a video in synchronization with haptic output rendered by the sensual medium generator 140. Evidently, such and other media rendering versions may be combined as desired.

Digital instructions for the sensual medium generator 140 to render one or more sensual media may be comprised by a sensual content file, a sensual content stream or any other sensual content format. The sensual content may be received by the terminal device 130 in the context of reception of other digital content, in particular A/V digital content, and either together with (e.g., in-band) or separate from (e.g., out-of-band) that other digital content.

With continued reference to FIG. 1, the network 100 further comprises a content server 150 (e.g., an Internet-based server offering media download or media streaming services). The content server 150 is located in the CPD. The content server 150 is configured to transmit digital content related to at least one sensual medium (such as a scent-enabled movie or haptically-enabled advertisement) towards the terminal device 130. The digital content may be generated by an application hosted by the content server 150. Content transmission from the content server 150 to the terminal device 130 takes place via the CND and the AND. The filtering apparatus 125 in the CND is configured to filter the resulting CND user plane traffic originating from the CPD as will be described in greater detail below. In such or other variants, filtering may additionally, or only, be applied locally at the CPD.

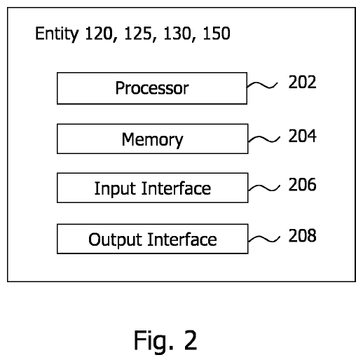

In the following, exemplary realizations of each of the retrieving apparatus 120, the filtering apparatus 125, the terminal device 130 and the content server 150 will be explained with reference to FIG. 2. As illustrated in FIG. 2, in one exemplary hardware implementation, each of the entities 120, 125, 130 and 150 comprises a processor 202 and a memory 204 coupled to the processor 202. The memory 204 stores program code that controls operation of the processor 202 to implement one or more aspects of the present disclosure. As understood herein, the processor 202 may be realized using any processing circuitry and is not limited to, for example, a single, localized processing core but may, for example, also have a distributed (e.g., cloud-based) topology.

Each of the entities 120, 125, 130 and 150 further comprises an optional input interface 206 and an optional output interface 208 for communication with other entities in the network 100 of FIG. 1. As an example, the input and output interfaces 206, 208 of the filtering apparatus 120 allow that entity 120 to retrieve filtering control information as input from the database 110 and to directly or indirectly (i.e., via one or more further entities) output the retrieved information to one or both of the filtering apparatus 125 and the CPD (e.g., to the content server 150 in the CPD). Additionally, similar interfaces 206, 208 allow each of the filtering apparatus 125 and the CPD to receive the filtering control information and digital content that needs to be filtered as input, and to output the filtered digital content. As a further example, the input and output interfaces 206, 208 of the terminal device 130 allow that entity 130 to communicate with the AND, the CND (e.g., to directly or indirectly write the filtering control information into the subscriber database 110) and with the generator 140.

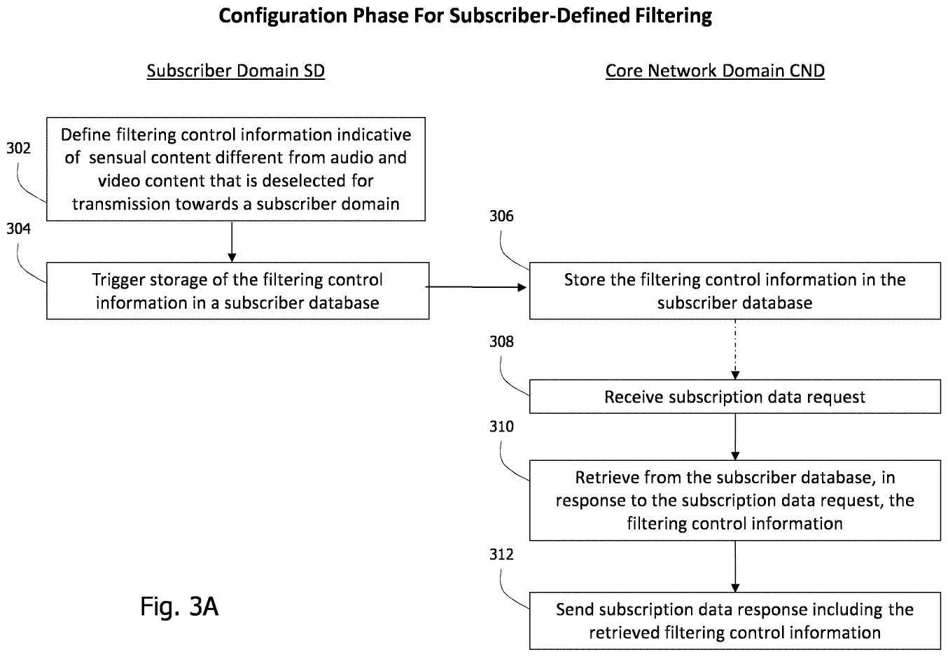

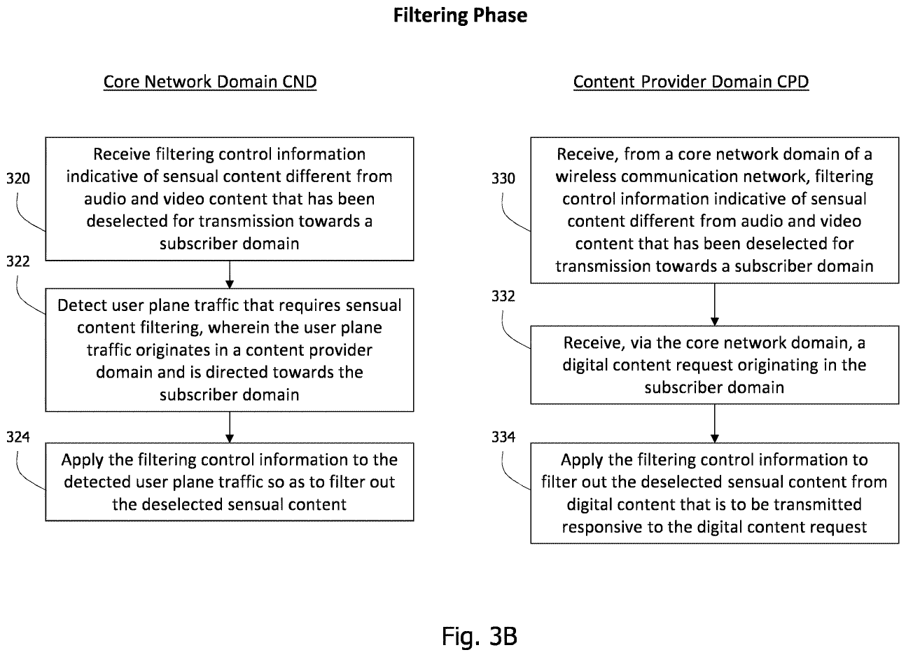

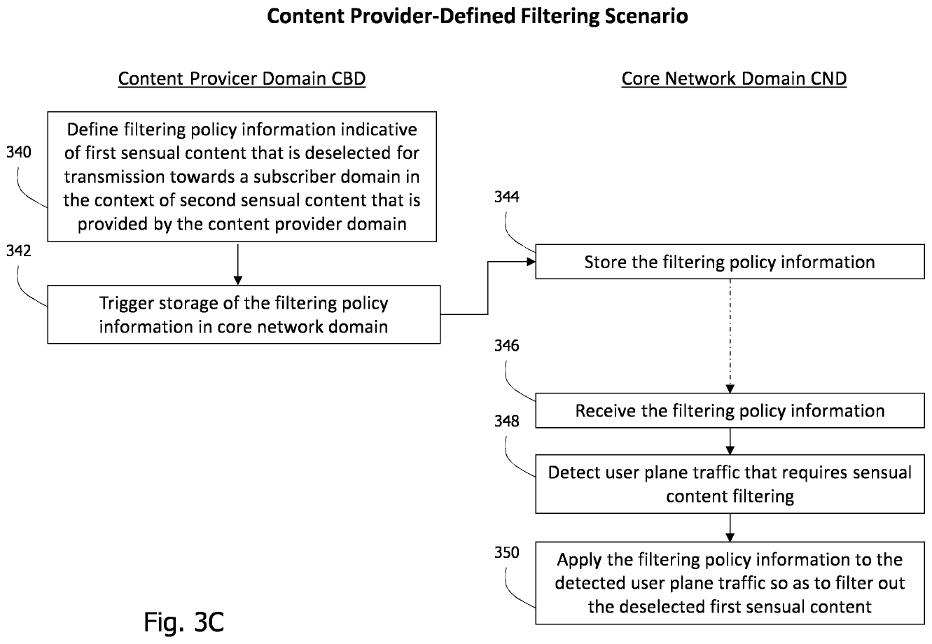

Exemplary modes of operation of the retrieving apparatus 120 and the filtering apparatus 125 in the CND, the terminal device 130 in the SD and the content server 150 in the CPD will now be described with reference to the flow diagrams illustrated in FIGS. 3A to 3C. These modes of operation relate to the handling of filtering control and policy information that defines sensual content different from A/V content that needs to be filtered out before being transmitted via the AND to the SD. As explained above with reference to FIG. 1, the user plane traffic that has been or is to be filtered originates from the CPD and, in more detail, from the content server 150. The content server 150 may host a Web application, a streaming application or any other application involving sensual content.

Before an actual content transmission session between the content server 150 in the CPD and the terminal device 130 in the SD takes place, the filtering control information in the subscriber database 110 of the CND will be configured by the SD to deselect sensual content (different from A/V content) for transmission towards the SD. An exemplary CND configuration phase is illustrated in the flow diagram of FIG. 3A, and the flow diagram of FIG. 3B shows a later filtering phase.

With reference to step 302 of FIG. 3A, configuration of the CND comprises defining, in the SD, filtering control information defining sensual content different from A/V content that is deselected for transmission towards the SD. As understood herein, such non-A/V sensual content can be deselected explicitly by indicating the non-A/V sensual content that is not to be transmitted towards the SD. Such non-A/V sensual content can also be deselected implicitly be selecting the non-A/V sensual content that is to be transmitted to the SD, wherein there exists further non-A/V sensual content that is not selected and, thus, will not be transmitted to the SD. Moreover, the deselection may relate to an entire sense type (e.g., touch-related digital content may entirely be deselected) or to dedicated sensual content item (e.g., the smell of a rose or a rough touch).

Step 302 can be performed by the terminal device 130 of FIG. 1 or any other terminal device (e.g., a personal computer or even the sensual medium generator 140) in the SD. Importantly, the device performing step 302 does not need to have wireless communication capabilities as step 302 can also be performed offline or via a wired connection. In some variants, the filtering control information is defined via a Web portal or an application running on the terminal device 130 or any other device in the SD. Such other terminal device will still belong to the SD since eventually one or more subscription-related credentials for authorisation and/or authentication (e.g., a password and/or any type of subscription identifier) are needed to trigger storage of the filtering control information in the subscriber database 110, see step 304 FIG. 3A.

As shown in FIG. 3A, storage of the filtering control information in the subscriber database 110 may be triggered in the SD, whereupon a message including the filtering control information is sent (directly or indirectly) to the CND. Upon receipt of the filtering control information in the CND, the filtering control information is stored in the subscriber database 110, see step 306 of FIG. 3A. The filtering control information may be sent to the CND in association with a subscription identifier so that the filtering control information can be stored in the subscriber database 110 for the subscription context associated with that subscription identifier. The subscription identifier may take any form that can be mapped in the CND to a particular subscription.

As an example, the filtering control information may be defined (e.g., entered) in step 302 via a graphical user interface provided by a Web portal and displayed on a screen of any terminal device operated by a subscriber. To access the Web portal, one or more subscription-related credentials have previously been entered (e.g., any identifier that can be mapped in the CND to a particular subscription). The Web portal may be offered by the MNO operating the CND. Storage of the filtering control information in the subscriber database 110 may be triggered (see step 304) by confirming the entered filtering control information. As an example, storage of the filtering control information may be triggered by clicking or otherwise activating a “confirmation” button on the graphical user interface provided by the Web portal. Of course, an application running on the terminal device may be operated in a similar manner, and steps 302 and 304 could also be performed in other ways.

There exist various reasons why a subscriber may wish to deselect sensual content different from A/V content for transmission towards the SD. In one variant, the subscriber may wish to only receive dedicated sensual content, and may wish to not receive other sensual content. If, for example, the CPD provides an A/V digital content that is enhanced with scent and tactile feedback, whereas the sensual medium generator 140 only supports scent-related technology, the subscriber may deselect the tactile content from being transmitted to the SD (e.g., for compatibility reasons or to save bandwidth). In other variants, the subscriber may have disabilities in his or her senses, such as in regard of scent (hyposmia, anosmia, parosmia, phantosmia) or touch (hypoaesthesia). In such variants, the subscriber may wish to deselect the non-A/V sensual content that cannot, or not properly, be consumed. In still other variants, the subscriber may prefer a central sensual content transmission control in the CDP over having to repeatedly configure a user profile for each of different CPDs.

While not illustrated in FIG. 3A, the terminal device 130 of FIG. 1 (or any other terminal device in the SD) may send a message indicative of whether or not the subscriber consents to exposure of the filtering control information, by the CND, to third parties such as the CPD. The consent message includes consent information defined by a subscriber in a dedicated step or when defining the filtering control information in step 302. Moreover, the consent message may be sent in a dedicated step or in the context of step 304, wherein the subscriber jointly triggers storage of the filtering control information and of the consent information in the subscriber database 110.

The consent information may be indicative of whether or not a subscriber gives his or her consent to exposure of the filtering control information to the CPD. In case the subscriber gives his or her consent, the CND is permitted to forward the filtering control information to the CPD. In such a case, the CPD may locally apply the filtering control information (meaning that pre-filtered content will eventually be routed from the CPD to the CND and from there via the AND to the SD, see FIG. 1).

In case the subscriber does not give his or her consent (or in case no consent information is available in the subscriber database 110), the filtering control information can only be applied in the CND (e.g., centrally for digital content received from a plurality of CNDs).

The filtering control information and, optionally, the subscriber consent information as stored in the subscriber database 110 may later be retrieved for configuration purposes. To this end, an entity in the CND (e.g., the retrieving apparatus 120 of FIG. 1) receives a subscription data request that includes an identifier associated with a subscription, see step 308 of FIG. 3A. In response to the subscription data request, the CND entity retrieves from the subscriber database 110 the filtering control information for the subscription associated with the identifier. As explained with reference to step 302, the filtering control information defines sensual content different from audio and video content that has been deselected for transmission towards the SD. Then, in step 312, the CND entity sends a subscription data response including the filtering control information. The subscription data response may be sent to another CND entity (e.g., a CND entity from which the subscription data request has been received in step 306).

The subscription identifier may be associated with a terminal device 130 (see FIG. 1) that has requested or will be requesting digital content that is to be filtered in accordance with the filtering control information. It is to be noted that multiple terminal devices may belong to a single description. The digital content may be requested in in the context of a digital content transmission session. As such, at least the receiving, retrieving and sending steps 308, 310, 312 may be performed in the context of (e.g., as a preparatory step of or during) a digital content transmission session.

Depending on the implementation, at least one of the receiving, retrieving and sending steps 308, 310, 312 may be performed by one of a unified data repository (UDR), a unified data management (UDM) entity and a policy control function (PCF) of a 5G-enabled CND or by one of a subscriber profile repository (SPR), a home subscriber server (HSS), and a policy and charging rules function (PCRF) of a 4G-enabled CND. For example, the subscription data request may be received by the UDR from the PCF, wherein the subscription data response is sent by the UDR to the PCF. As a further example, the subscription data request is received by the UDM entity from the PCF, wherein the subscription data response is sent by the UDM entity to the PCF.

While not illustrated in FIG. 3A, the CND entity performing steps 308, 310, 312 may receive an earlier subscription data request preceding the subscription data request received in step 308 and including the identifier (or another identifier) associated with the subscription. The CND entity may then retrieve from the subscriber database 110, in response to the earlier subscription data request, filtering status information for the subscription associated with the identifier. The filtering status information defines whether or not sensual content filtering is to be applied for the subscription. The filtering status information may be defined and stored as explained above with reference to steps 302 and 304 of FIG. 3A. The CND entity may then send a further subscription data response including the filtering status information. As an example, the earlier subscription data request may be received by the UDM entity from a session management function (SMF) of the 5G-enabled CND, and the associated subscription data response is sent by the UDM entity to the SMF. Based on the filtering status information received in the subscription data response, the SMF may specifically select the PCF that is to send the subscription data request of step 308 to be such a PCF that supports sensual content filtering. The SMF may then receive the filtering control information from the PCF and select, based on the filtering control information received from the PCF, a user plane function (UPF) of the 5G-enabled CND to be a UPF that supports sensual content filtering.

The filtering control information retrieved in step 310 of FIG. 3A may be provided to a filtering apparatus that is either located in the CND (see flow diagram on the left-hand side of FIG. 3B) or in the CPD (see flow diagram on the right-hand side of FIG. 3B). Of course, the filtering control information may only be provided to the CPD in case the subscriber has given his or her consent, as explained above.

Steps 320 to 324 illustrate filtering of user plane traffic in the CND. With reference to step 320, a CND entity (such as the filtering apparatus 125 of FIG. 1) receives filtering control information defining sensual content different from A/V content that has been deselected for transmission towards the SD. The filtering control information may have previously been retrieved from the subscriber database 110 (see steps 308, 310 and 312 in FIG. 3A). In step 322, the CND entity detects user plane traffic that requires sensual content filtering. As explained above with reference to FIG. 1, the user plane traffic originates in the CPD and is directed towards the SD. Detecting the user plane traffic may comprise at least one of applying one or more traffic detection rules to the user plane traffic, performing traffic analytics, and detecting predefined traffic flows. The traffic detection rules may be received by the CND entity performing step 322 in a configuration message.

In step 324, the CND entity applies the filtering control information to the detected user plane traffic so as to filter out the deselected sensual content. In some implementations, steps 320 to 324 are performed by a UPF of a 5G-enabled CND or a user plane packet date network gateway (PGW-U) of a 4G-enabled CND.

Steps 330 to 334 of FIG. 3B illustrate filtering of user plane traffic in the CPD. In step 330, the content server 150 or any other filtering apparatus in the CPD receives, from the CND, filtering control information defining sensual content different from A/V content that has been deselected for transmission towards the SD. The filtering control information may have previously been retrieved from the subscriber database 110 (see steps 308, 310 and 312 in FIG. 3A). In step 332, the CPD receives, via the CND, a digital content request originating in the SD. Steps 330 and 332 can be performed in any order. Then, in step 334, the CPD applies the filtering control information to filter out the deselected sensual content from digital content that is to be transmitted responsive to the digital content request.

In some variants, provisioning of filtering control information to the CPD (step 330) is supported by the CND as a service on a subscription basis. In such variants, the CPD may send a subscription message to the CND. The filtering control information may then be received in reaction to the subscription (and, optionally, initiation of a content transmission session). The subscription message may further include one or more of the following informational items: an identifier of an application server or application function as originator of the digital content transmission (see reference numeral 150 in FIG. 1), an identifier of an application providing the digital content (e.g., Netflix or YouTube) a sensual type identifier (e.g., scent or tactile feedback), a sensual content identifier (e.g., ID=xy for the scent of a rose), and a content recipient identifier (e.g., an identifier of the terminal device 130). The subscription message may be sent by the CPD to a network exposure function (NEF) of a 5G-enabled CND or a service capability exposure function gateway (SCEF) of a 5G-enabled CND.

In certain implementations, the CND filtering may also be controlled based on filtering policy information received by the CND from the CPD (e.g., in addition or as an alternative to CND filtering that is based on filtering control information as received from the SD, see FIGS. 3A and 3B). As an example, a first content provider may wish to exclude that its own sensual content is rendered in a context of (e.g., shortly before, concurrently with, or shortly after) certain sensual content provided by a second content provider. Assume, for example, that the first content provider provides a scent-enabled advertisement for a perfume and wishes to exclude that another scent-enabled advertisement (e.g., of a second content provider) is rendered immediately before or after the scent-enabled advertisement for the perfume to make sure that only the scent of the perfume lingers on in the SD.

Exemplary implementations in which the CND filtering is based on filtering policy information received from the CPD will now be discussed with reference to the flow diagrams of FIG. 3C.

A first flow diagram illustrating the provisioning of filtering policy information from the CPD to the CND is illustrated on the left-hand side of FIG. 3C. In step 340, the content server 150 or another entity in the CPD defines filtering policy information (e.g., via a Web interface or otherwise). The filtering policy information is indicative of first sensual content different from audio and video content (e.g., any scent-related digital information) that is deselected for transmission towards the SD in the context of second sensual content different from audio and video content (e.g., a scent-enabled advertisement for a perfume) that is provided from the CPD. Step 340 may be performed in a similar manner as step 302 of FIG. 3A. Then, in step 342, the CPD triggers storage of the filtering policy information in the CND. As an example, the filtering policy information may be provided to and, optionally, stored by a network exposure function (NEF) of a 5G-enabled CND (see step 344). Step 342 may be performed in a subscription context, for example by transmitting a subscription message carrying the filtering policy information from the CND to the NEF.

The right-hand side of FIG. 3C illustrates filtering of user plane traffic in the CND, for example by the filtering apparatus 125. In step 346 the filtering apparatus 125 (e.g., a UPF) receives the filtering policy information. The filtering policy information may directly or indirectly (i.e., via a further CND entity) be received from the NEF.

In step 348, the filtering apparatus 125 detects user plane traffic that requires sensual content filtering. Then, in step 350, the filtering apparatus applies the filtering policy information to the detected user plane traffic so as to filter out the deselected first sensual content in the context of the second sensual content. This means that only the second sensual content can pass on to the SD, whereas the first sensual content is blocked from being transmitted to the SD. The first sensual content may be intended to immediately precede or follow the second sensual content. The first and second sensual content may be provided by different content providers.

The above general realizations of the present disclosure will now be described in greater detail with reference to certain technical specifications (TSs) defined by the 3rd Generation Partnership Project (3GPP) for 5G communication systems. 3GPP TS 23.501 V15.4.0 (2018-12) and later defines architectural aspects of a 5G service based architecture (SBA). According to this SBA, NFs use service-based interactions to consume services from other NFs. The discovery of services and of NFs producing them is provided by a network repository function (NRF). Service producing NFs register, update or deregister their profiles in the NRF. Service consuming NFs discover services offered by NF producer instances by querying the NRF about NF instances offering services of a given type. NFs may subscribe and unsubscribe to changes in the status of NFs registered in the NRF, as explained with reference to the provisioning of filtering control information to the CPD. Based on such subscriptions, the NRF may notify NFs of status changes of other NFs.

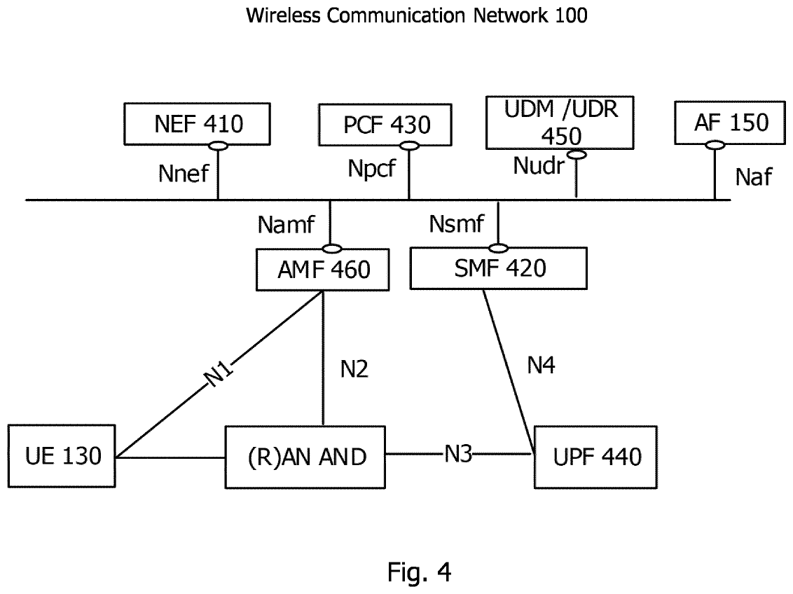

FIG. 4 depicts a portion of the 5G reference architecture as defined by 3GPP (see, e.g., Section 4.2.3 of 3GPP TS 23.501 V15.4.0 and later). The relevant architectural core network entities (i.e., NFs), core network interfaces and other network entities for some realizations of the present disclosure include the following:

A user equipment (UE) is an exemplary terminal device 130 (see FIG. 1). UE 130 constitutes, for example, an endpoint of a non-A/V sensual medium enabled streaming or download session that stretches via the AND and the CND. The AND is configured as a radio access network (RAN). In some variants, the UE 130 is configured to output, or to trigger output, of at least one non-A/V sensual medium in the CRD (e.g., via the generator 140 illustrated in FIG. 1)

An application function (AF) is typically implements the content server 150 operated by a dedicated content provider (e.g., an over-the-top, OTT, entity). The AF 150 is configured to interact with the CND via an Naf interface and, in particular, via one or more dedicated exposure APIs. The AF 150 is in some implementations configured to provide non-A/V sensual medium enabled streaming or download services.

A network exposure function (NEF) 410 has an Nnef interface and supports different functionalities. Specifically, in the context of the present disclosure, the NEF 410 acts as an entry point into the CND for the AF 150. The AF 150 thus interacts with the CND through the NEF 410. 3GPP has defined an exposure framework with a northbound interface between the AF 140 and the NEF 410 that supports dedicated APIs, including, as an option in the present context, an optional API to exchange information between the CND and the CPD about filtering control information.

A session management function (SMF) 420 has N4 and Nsmf interfaces. The SMF 420 supports procedures such as session establishment, modification and release as well as policy-related functionalities. The SMF 420 is configured to receive policy and charging control (PCC) rules from a policy control function (PCF) 430. Moreover, the SMF 420 configures a user plane function (UPF) 440 accordingly through the N4 interface using the packet forwarding control protocol (PFCP).

A user plane function (UPF) 440 has an N4 interface to SMF 420 and an N3 interface to AND. The UPF 440 supports handling of user plane traffic (i.e., digital content) based on the rules received via the SMF 420 from the PCF 430. Specifically, in certain variants of the present disclosure, the UPF 440 supports traffic inspection (through packet detection rules, PDRs), and further supports the application of associated traffic handling actions such as traffic filtering, traffic steering, QoS enforcement, charging/reporting, and so on. In some variants, UPF 440 implements the filtering apparatus 125 of FIG. 1 or at least a component thereof.

A policy control function (PCF) 430 supports, via an Npcf interface, a unified policy framework to govern the CND behavior. Specifically, the PCF 430 provides PCC rules to SMF 420 and/or UPF 440 to detect user plane traffic that requires filtering and to enforce policy and charging decisions according to the PCC rules.

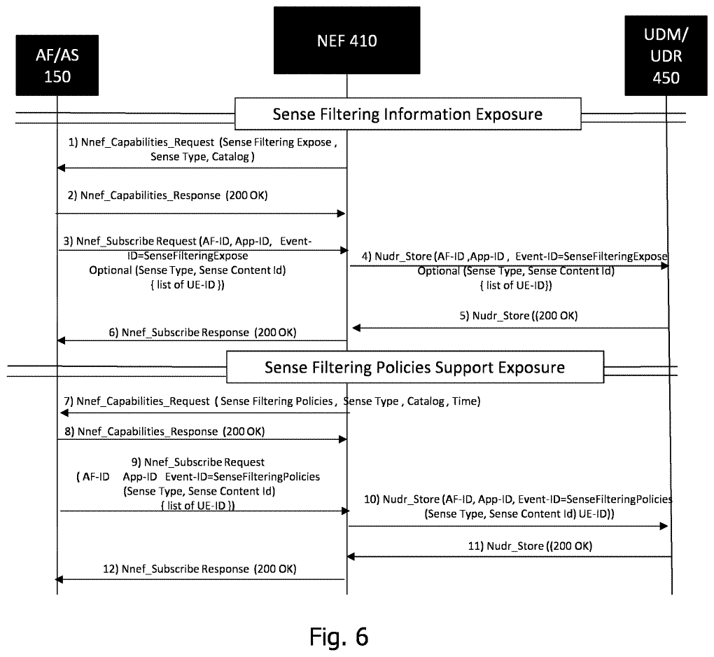

A unified data management (UDM) entity 450 centrally handles data (in particular subscriber information) in the core network domain CND. To this end, UDM 450 hosts or has access to a unified data repository (UDR) that, in turn, hosts the subscriber database 110. The UDM 450 itself may store session context information for later retrieval by the PCF 430 when a session is created. Some NFs may access the UDR (with its subscription database 110) directly and some only via the UDM 450. In the context of the signalling diagrams of FIGS. 6 to 10, the designation UDM/UDR 450 expresses both possibilities, although the UDM 450 may in some variants be bypassed.

An access and mobility management function (AMF) 460 handles access and mobility for UE 130.

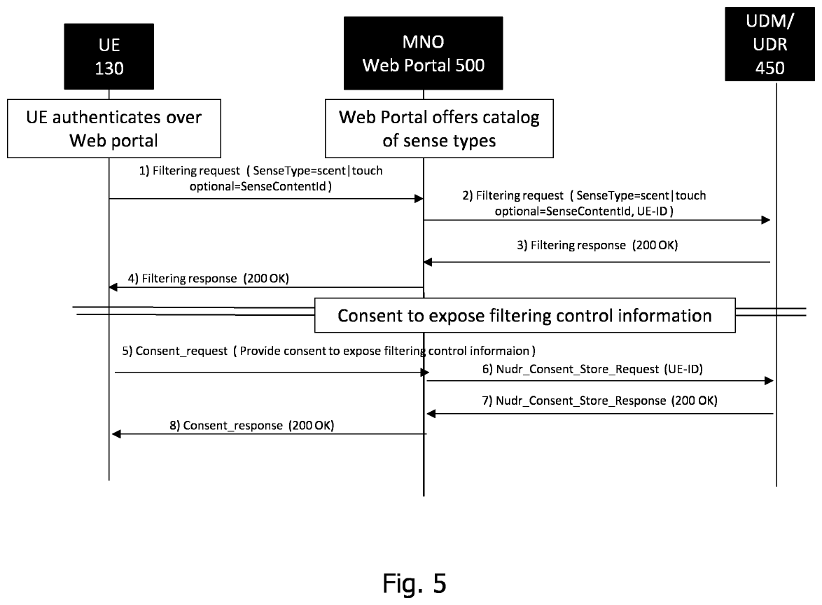

In the following description, exemplary 5G signaling realizations implementing aspects of the present disclosure will be described with reference to FIGS. 5 to 10 and the 5G entities discussed above with reference to FIG. 4. It will be apparent to one skilled in the art that similar signaling realizations will apply in case of a 4G or a combined 4G/5G implementation.

FIG. 5 shows an example of a 5G signaling procedure for implementing an aspect of the CND configuration phase. In more detail, FIG. 5 illustrates an exemplary 5G realization of a subscriber defining filtering control information and triggering storage thereof in the subscriber database 110 (as generally explained above with reference to FIG. 3A, see steps 302, 304 and 306). In this way, each subscriber can define, or configure, filtering control information to deselect specific non-A/V sensual content from being transmitted to the respective SD. As explained above, individual subscribers may wish not to receive a specific scent (e.g., in case of anosmia) or no scent-related digital content at all (e.g., because of lacking technical support in the subscriber domain), while other non-A/V related digital content is desired (e.g., other scents) or supported (e.g., touch-related digital content).

As illustrated in FIG. 5, the UE 130 (or any other terminal device in a certain SD) initially authenticates itself over a Web portal 500 provided by the MNO operating the wireless communication network 100. The Web portal 500 offers a catalog of general sense types and individual sensual contents that can be deselected. Moreover, the Web portal 500 enables a subscriber to consent to exposure of the deselected sensual content (in terms of filtering control information) to CPDs.

As said, the Web portal 500 offers a catalog (e.g., a list) of general sense types and individual sensual contents that can be deselected via the UE 130 (after authentication) to define the filtering control information (see step 302 of FIG. 3A). In step 1) of FIG. 5, the UE 130 triggers storage of the corresponding filtering control information in the subscriber database 110 by sending a filtering request message to the Web Portal 500 (see steps 304 and 306 in FIG. 3A). In the example of FIG. 5, the filtering request message indicates the sense type that is deselected (e.g., scent or touch or both). In the alternative, or in addition, the filtering request message includes one or more dedicated sensual contents that are deselected by indicating an identifier of the deselected sensual content (e.g., 1=scent of a rose). The filtering control information thus includes the sense type and/or sensual content information in the filtering request message. The filtering request message may also be indicative of an identifier of the UE 130 (UE-ID) so that the associated subscription can be identified in the CND. In other variants, the subscription (or the associated UE-ID) is inferred by the Web portal 500 upon authentication of the UE 130.

In step 2), the Web portal 500 sends the filtering control information together with the UE-ID or any other subscription identifier to the UDM/UDR 450. The UDM/UDR 450 stores the filtering control information in the subscriber database 110 and in association with the subscription associated with the UE 130.

In step 3), storage of the filtering control information is acknowledged by the UDM/UDR 450 to the Web portal 500, which in turn acknowledges this fact to the UE 130 in step 4).

As explained above, the Web portal 500 also enables a subscriber to consent to exposure of the deselected sensual content (in terms of filtering control information) to CPDs or other third parties, as will now be explained with reference to steps 5) to 8) of FIG. 5. Steps 5) to 8) can be performed before or after steps 1) to 4).

In step 5) of FIG. 5, the UE 130 triggers storage of the corresponding consent information in the subscriber database 110 by sending a consent request message to the Web Portal 500. The consent information may have a binary format “yes”/“no”. A default consent setting in the subscriber database 110 may be “no”.

In step 6), the Web portal 500 sends the consent information together with the UE-ID or any other subscription identifier to the UDM/UDR 450. The UDM/UDR 450 stores the filtering control information in the subscriber database 110 and in association with the subscription associated with the UE 130.

In step 7), storage of the consent information is acknowledged by the UDM/UDR 450 to the Web portal 500, which in turn acknowledges this fact to the UE 130 in step 8).

FIG. 6 shows further examples of 5G signaling procedure for implementing further aspects of the CND configuration phase. In the signaling procedures of FIG. 6, the CND exposes sensual content-related capability information to the CPD. In particular, this capability information relates to the CND's capability to expose filtering control information to the CPD on a subscription basis to the SPD (see steps 1) to 6) of FIG. 6) and the CND's capability to consider one or more content provider-defined policies for sensual content filtering (see steps 7) to 12 of FIG. 6).

In step 1) of FIG. 6, the NEF 410 exposes the CND's capability to expose filtering control information to the CPD. To this end, the NEF 410 by sends a corresponding Nnef_Capabilities_Request message to the AF 150. In many cases, this message will be sent to multiple AFs 150 of different content providers. The Nnef_Capabilities_Request message includes the following parameters:
Sense filtering expose: the CND is able to expose for those subscribers who have provided their consent the non-A/V sensual content that has respectively been deselected
Sense Type: indicates for which type of non-A/V sensual content (e.g., scent and/or tactile) this exposure service is allowed or possible
Catalog: list of non-A/V sensual content per sense type for which this exposure service is allowed or possible (e.g., a list of corresponding sensual content identifiers, such as 1—Rose; 2—Jasmine etc. for the sense type “scent”)

In step 2) of FIG. 6, the AF 150 confirms receipt of the Nnef_Capabilities_Request message.

In step 3), the AF 150 subscribes to the event of sense filtering exposure by sending an associated subscription message to the NEF 410. As illustrated in FIG. 6, the event has the Event-ID=SenseFilteringExpose. The subscription message further includes the following informational items: an identifier of the application server or application function 150 subscribing to the event, an identifier of the associated application providing the digital content (e.g., Netflix or YouTube), and a list of UE identifiers for which the subscription is made (can also be “all UEs”). The subscription message may optionally include a sense type identifier (e.g., scent or tactile feedback) and a sensual content identifier from the catalog (e.g., ID=1 for the scent of a rose).

An exemplary subscription message may define the following parameters:
AF-ID (e.g., =Netflix Inc)
App-ID (e.g., =Netflix)
UE-ID: Identifier(s) of a specific UE(s) or indication of “all UEs”
Event-Id=SenseFilteringExpose
At least one of these optional parameter sets may be included:
   Sensual Type: scent or tactile
   Catalog ID: identifier of the sensual content in the catalog

The parameter App-ID not being present or not being associated with any particular parameter value (such as “Netflix”) can be interpreted in certain variants as being indicative of “any App”.

In step 4), the NEF 410 sends the content of the subscription message (as received in step 3) of FIG. 6) to the UDM/UDR 450 for storage (e.g., in the subscriber database 110).

In step 5), the UDM/UDR 450 confirms storage to the NEF 410, which triggers the NEF 410 to send a Nnef_Subscribe Response message to the AF 150 in step 6).

After having performed steps 1) to 6), the CND will expose to the AF 150 filtering preferences of individual subscribers (provided that corresponding filtering control information is available in the subscriber database 110 and that the subscribers have given their consent).

Still in the configuration phase, the CND may also expose to the AF 150 its capability to consider dedicated CPD-defined sense filtering policies. As explained above with reference to FIG. 3C, such CPD-defined filtering policies will be taken into account in addition to the subscriber-defined filtering control information (see step 302 in FIG. 3A and step 1) in FIG. 5) when user plane traffic filtering is applied in the CND.

The definition of filtering policy information indicative of one or more sense filtering policies by the CPD will now be explained with reference to steps 7) to 12) of FIG. 6. Steps 7) to 12) of FIG. 6 can be performed before of after steps 1) to 6). In some variants, only steps 1) to 6) or only steps 7) to 12) are performed.

In step 7) of FIG. 6, the NEF 410 exposes filtering policies-related capability information in a Nnef_Capabilities_Request message to the AF 150 in the CPD. In many cases, this message will be sent to multiple AFs 150 of different content providers. The Nnef_Capabilities_Request message sent in step 7) includes the following parameters:
Sense filtering policies: the CND is able to filter out non-A/V sensual content based on the following parameters
   Sense Type: indicates for which type of non-A/V sensual content (e.g., scent and/or tactile) this service is allowed or possible
   Catalog: list of non-A/V sensual content per sense type that can be filtered out (e.g., a list of corresponding sensual content identifiers, such as 1—Rose; 2—Jasmine etc. for the sense type “scent”)
   Time: indicates when the policy is valid or active (e.g., time of day, calendar day(s), etc.)

In step 8) of FIG. 6, the AF 150 confirms receipt of the Nnef_Capabilities_Request message.

In step 9), the AF 150 subscribes to the event of exposing sense filtering policies by sending an associated subscription message to the NEF 410 (in a similar manner as explained above with reference to step 3) of FIG. 3C). As illustrated in FIG. 6, the event has the Event-ID=SenseFilteringPolicies. The subscription message further includes the following informational items: an identifier of the application server or application function 150 subscribing to the event, an identifier of the associated application providing the digital content (e.g., Netflix or YouTube), and a list of UE identifiers for which the subscription is made (can also be “all UEs”). The subscription message will in particular include filtering policy information (see step 340 in FIG. 3C) comprising at least one of a sense type identifier (e.g., scent) and a sensual content identifier from the catalog (e.g., ID=1 for a pepperminty scent). The filtering policy information may further comprise the Time parameter indicated above. In this way the AF 150 can control that (and when) the CND will filter out sensual content provided by other AFs to a particular SD (or all SDs) in case that sensual content includes a pepperminty scent and is scheduled to be rendered in a close temporal context with (e.g., shortly after) the sensual content provided by the AF 150 to the particular SD (or all SDs).

In step 10), the NEF 410 sends the content of the subscription message, i.e., the filtering policy information (as received in step 9) of FIG. 6) to the UDM/UDR 450 for storage (e.g., in the subscriber database 110), see steps 342 and 344 in FIG. 3C. The filtering policy information may be stored for each indicated UE identifier or centrally for all UEs 130.

In step 11), the UDM/UDR 450 confirms storage to the NEF 410, which triggers the NEF 410 to send a Nnef_Subscribe Response message to the AF 150 in step 12).

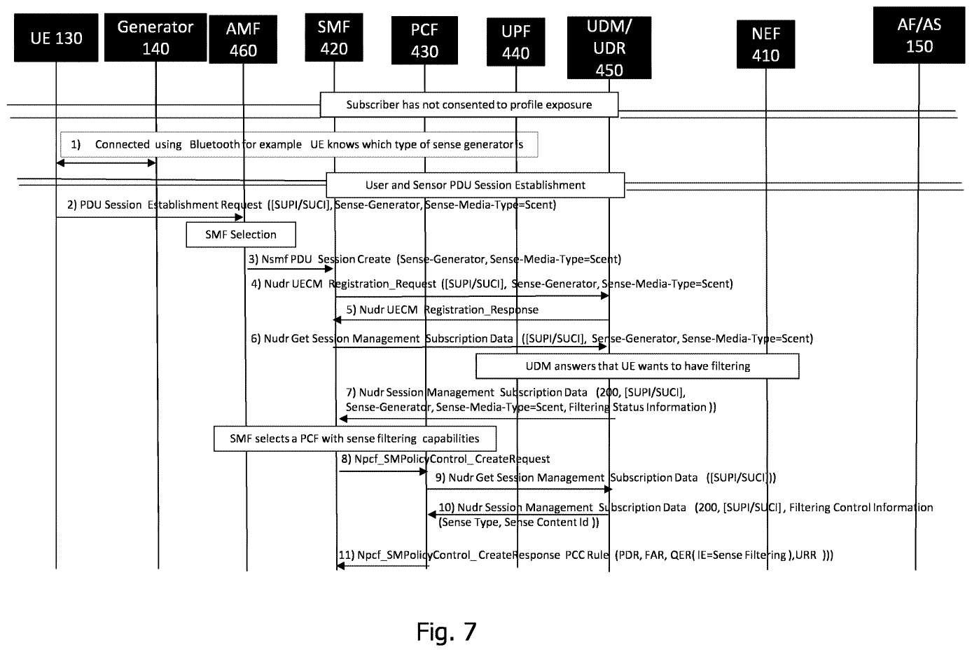

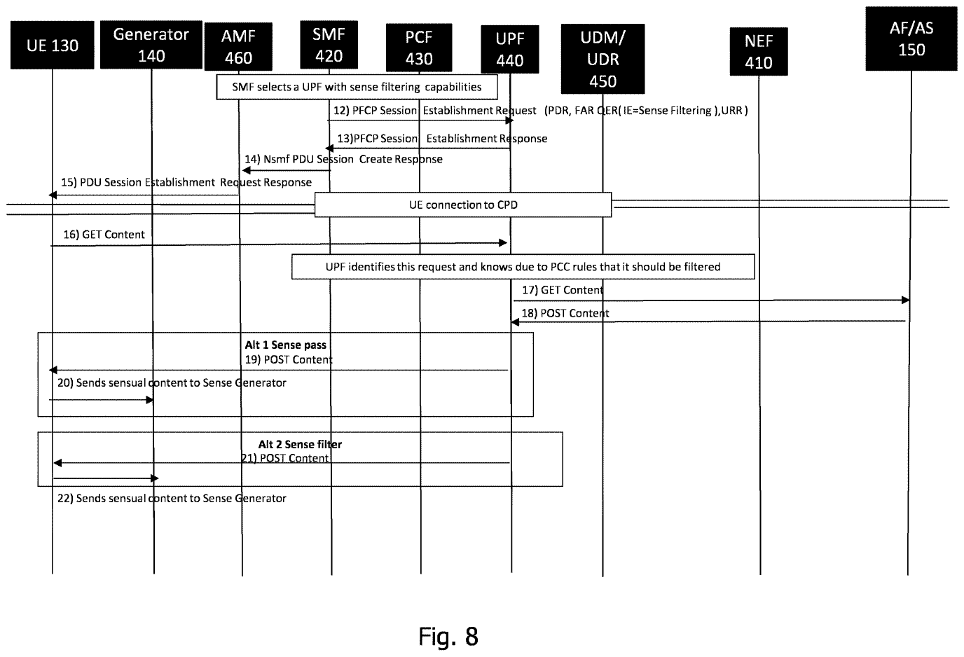

FIGS. 7 and 8 illustrate an example of the 5G signaling procedure for implementing the traffic filtering phase in the CND as generally discussed above with reference to FIG. 3B (left-hand side). The signaling diagrams of FIGS. 7 and 8 illustrate the steps of session establishment and also the associated digital content transmission session. It will be assumed that the configuration phase (see FIG. 3A, FIG. 5 and FIG. 6) has been completed. It will further be assumed, that the subscriber associated with UE 130 has not given his or her consent to exposure of hso or her filtering control information to third parties such as a content provider.

In signaling step 1) of FIG. 7, UE 130 will connect using, for example, personal area network (PAN) connectivity to sensual medium generator 140. Bluetooth and other technologies can be used as well. As an alternative not depicted in the drawings, the generator 140 may have a subscriber identity module (SIM) that can connect to the AND (see FIG. 1). As such the generator 140 can itself be configured as a “UE”.

Using signaling between UE 130 and generator 140, or using a pre-configured context, UE 130 knows the type of generator 140 it is connected to. In this example, it is a scent generator 140 capable of providing an olfactory medium.

In step 2) of FIG. 7, UE 130 triggers a PDU Session Establishment Request towards the CND (here: AMF 460). The corresponding message includes a subscription identifier associated with the UE 130 (e.g., a subscription permanent identifier, SUPI, and/or subscription concealed identifier, SUCI) and a parameter informing the CND about SD capabilities in regard to support of at least one non-A/V sensual medium. This parameter is exemplarily called SenseGenerator. It is a Boolean parameter (e.g., “support/” no support”), but other formats can be used as well. In the present realization, the parameter is associated with an optional indicator (Sense-Media-Type) defining which type of non-A/V sensual medium is supported. In this case, the indicator has the value “Scent” (i.e., is indicative of olfactory medium support by the generator 140 in the CRD).

In step 3) of FIG. 7, the AMF 460 sends a Nsfm Session Create message to the SMF 420. This messages includes the SUPI/SUCI and the subscriber capability information (SenseGenerator, Sense-Media-Type) received from the UE 130 in step 2).

Then, in signaling step 4) of FIG. 7, the SMF 420 registers the SUPI/SUCI and the subscriber capability information via UDM/UDM 450 (e.g., in the subscriber database 110) by way of a Nudr_UECM_Registration_Request message. In more detail, the subscriber capability information is registered in a user profile of the subscription associated with the SUPI/SUCI. The registered information includes the parameter SenseGenerator and the associated value Sense-Media-Type=Scent. In step 5), the UDM 450 acknowledges the registration with a registration response message to the SMF 420.

In step 6) of FIG. 7, the SMF 420 requests subscription profile information from the UDM 450 via a Nudr_Get_Session_Management_Subscription_Data message, and in signaling step 7), the UDM 450 sends the requested information (e.g., as retrieved from the subscriber database 110) to the SMF 420. This information includes the subscriber capability information (SenseGenerator, Sense-Media-Type) as transmitted by UE 130 in step 2). Importantly, this information also includes filtering status information for the subscription associated with the SUPI/SUCI. The filtering status information (e.g., in the form of a flag or Boolean parameter) defines whether or not filtering is to be applied for the subscription. The filtering status information may be set (e.g., by the UDM/UDR 450) dependent on whether or not filtering control information is available for the subscription.

In signaling step 8) of FIG. 7, the SMF 420 establishes an association with a PCF 440. In more detail, the SMF 420 selects a PCF 430 for session handling. In this regard, the SMF 420 selects the PCF 430 considering that the current session requires “SenseGenerator with Sense-Media-Type=Scent” capabilities and sensual content filtering capabilities from the PCF 440.

In step 9) of FIG. 7, the PCF 430 requests retrieval of subscription data for the SUPI/SUCI from the UDM 450. In more detail, the PCF 430 queries the UDM 450 for any specific subscriber policies. In step 10), the UDM 450 responds to the PCF 450 with an indication of filtering control and/or filtering policy information that is to be applied for the UE 130. In more detail, the filtering control and/or policy information indicates the sense type and/or sensual content ID(s) that have been deselected by a subscriber and/or content provider for transmission towards the SD. The UDM retrieves the filtering control and/or policy information from the subscriber database 110, where it has been stored as explained above with reference to FIGS. 3A, 3C, 5 and 6.

Then, in signaling step 11) of FIG. 7, the PCF 430 responds to the SMF 420. In more detail, the PCF 430 transmits the general policies that need to be applied by an UPF 440 on the user plane. In the present case, the PCF 430 transmits a new parameter in a quality of service enforcement rule (QER), but it could also be transmitted in a forwarding action rule (FAR). The new parameter may in some variants take the form of a new information element (IE) to be supplemented in the QER IEs in Table 7.5.2.5-1 of 3GPP technical specification TS 29.244 V17.3.0 (December 2021) or newer. The new IE may be designated “Sense Filtering” and may be optional. This IE may be present if the UPF 440 indicated support of Sense Filtering of downlink traffic directed towards the SD. The following interfaces may be supported: Sx b, Sx c and N4.

When present, the new Sense Filtering IE shall contain the filtering control information or a portion thereof. The same or a different IE may be used for the filtering policy information. In the following, primarily the processing of the Sense Filtering IE that contains the filtering control information will be described in greater detail. It will be appreciated that an IE carrying the filtering policy information will be processed in a similar manner.

The Sense Filtering IE type may be defined as shown in the table below. It may be of a new type=300 not used in the current specification. The Sense Filtering IE will contain information related to the non A/V sensual content that is to be filtered out. As an example, it may indicate a parameter Sense Type.

| | Bits | | | | | | | |
|---|---|---|---|---|---|---|---|---|
| Octets | 8 | 7 | 6 | 5 | 4 | 3 | 2 | 1 |

| 1 to 2 | Type = 300 (decimal) | |
|---|---|---|
| 3 to 4 | Length = n | |
| 5 | Spare | Sense Type |

| | |
|---|---|
| 6 | Length of Sense Field Name |
| 7 to m | Sense Field Name |
| p | Length of Sense Field Value |
| (p + 1) to q | Sense Field Value |
| s to (n + 4) | These octet(s) is/are present only if explicitly specified |

The Sense Type parameter indicates the type of the sensual content that is to be filtered out (as defined in the filtering control information).

| | Value |
|---|---|
| Sense Type | (Decimal) |
| Scent | 0 |
| Tactile | 1 |
| Spare, for future use. | 2 to 31 |

The parameters are defined as follows:
Length of Sense Field Name indicates the length of the Sense Field Name.
Sense Field Name shall be encoded as an OctetString.
Length of Sense Field Value indicates the length of the Header Field Value
Sense Field Value shall be encoded as an OctetString.

Now referring to FIG. 8, the SMF 420 will next select a UPF 440 that is capable of filtering out the non-A/V sensual content as defined in the Sense Filtering IE. Thus, in step 12) of FIG. 8, the SMF 420 establishes a connection towards a particular UPF 440. In more detail, the SMF 420 selects a UPF 440 for session handling considering the subscriber capability information (including “SenseGenerator with Sense-Media-Type=Sent”) and the filtering requirement. In this context, the SMF 420 transmits a PFCP Session Establishment Request message with the PDR and the QER including the Sense Filtering IE, as explained above (see also step 320 of FIG. 3B). In step 13), the selected UPF 40 acknowledges receipt of PFCP Session Establishment Request message to the SMF 420.

The SMF 420 in step 14) acknowledges the AMF request (as received in step 3) of FIG. 7) with a Nsmf PDU Session Create Response message. Then, in step 15), the AMF 460 acknowledges the UE request as received in step 2) by returning a PDU

Session Establishment Request Response to the UE 130. At this point, the PDU session is established.

It will be appreciated that the generator 140 may be enabled, or activated, for some sessions and not enabled, or deactivated, for other sessions. As such, the validity of the subscriber capability information will be limited by the UDM 450 to a single PDU session for digital content transmission. The subscriber capability information in the subscriber database 110 may thus be deleted when the session is terminated.

With continued reference to FIG. 8, in signaling steps 16) and 17), the UE 130 requests digital content from the AF 150. In the present example, the requested digital content includes sensual content for the generator 140 to render an olfactory medium so as to enable a scent-related user experience and it may also include a tactile medium for a haptic user experience (e.g., in the context of video or audio streaming or in the context of an advertisement). The UE's request for non-A/V sensual content-enabled media is identified by the UPF 440 based on the PCC rules (including the QER with the new Sense Filtering IE), and the UPF 440 thus infers that there is a requirement of user plane traffic filtering. The UPF 440 may detect traffic in a “regular” manner, i.e., based on PDR matching for a certain App-ID, which is associated with an QER indicating a filtering action.

In step 18), the AF 150 starts transmitting the digital content requested by the UE 130. The digital content transmitted by the AF 150 will include non-A/V sensual content that has previously been deselected for transmission to the SD (see steps 1) to 4) of FIG. 5). In more detail, the subscriber has chosen earlier that his or her filtering control information is not to be disclosed to the CPD (see steps 5) to 8) of FIG. 5). As such, the CPD (and the AF 150 in particular) is unaware of the fact that such a deselection has taken place.

Between steps 18) and 19), and between steps 18) and 21), the UPF 440 detects, on the user plane, the digital content traffic transmitted by the AF 150 (see also step 322 of FIG. 3B). Since the UPF 440 has inferred that there is a requirement of user plane traffic filtering for this session, it uses the content of the Sense Filtering IE in the QER to apply the associated filtering control information to the detected user plane traffic so as to filter out the deselected sensual content (see step 324 of FIG. 3B). The trigger for the UPF 440 to perform the filtering operation is the detection of downlink traffic matching the PDR for the App-ID associated with a QER including the Sense Filtering IE type.

The operation of the UPF 440 depends on whether or not the digital content traffic transmitted by the AF 150 includes non-A/V content that has been deselected for transmission to the UE 130. If, for example, the subscriber has previously deselected sensual content relating to a tactile user experience (since just a scent-related user experience is desired or technically possible in the SD) and if the digital content traffic does not include such tactile sensual content, the UPF 440 infers that no filtering is required and the digital content traffic is simply forwarded to the UE 130 without any filtering (see step 19)). If, on the other hand, the subscriber has previously deselected sensual content relating to a tactile user experience and if the digital content traffic does include such tactile sensual content, the UPF 440 infers that filtering is required and filters out the tactile sensual content from the digital content traffic. The filtered digital content traffic (only including scent-related sensual content) is then forwarded to the UE 130 (see step 21)).

In the context of steps 18) to 22), the UPF 440 will also consider the AF-defined filtering policy information (see steps 7) to 12) of FIG. 6 and steps 348 and 350 of FIG. 3C) but with respect to non-A/V sensual content provided by a different AF. That is, in the context of step 18) to 22) non-A/V sensual content of another AF is to be transmitted to the UE 130, the UPF 440 filters out such content or content portions that match the filtering policy information defined by the AF 150.

In each of the alternatives set forth above, the UE 130 receives the digital content traffic and sends the scent-related sensual content (e.g., in the form of a digital file) to the generator 140 for rendering. The digital content traffic may further include A/V content that can be rendered by the UE 130 directly or by another rendering device. As an example, the A/V content may be rendered by a television set in communication with the UE 130, while the sensual content is rendered in parallel by the generator 140.

In some implementations, the identification of user plane traffic that requires sensual content filtering may be different from the scenario illustrated in FIGS. 7 and 8. For example, the UPF 440 may locally perform traffic analysis by applying a suitable analytics algorithm (e.g., based on deep packet inspection).

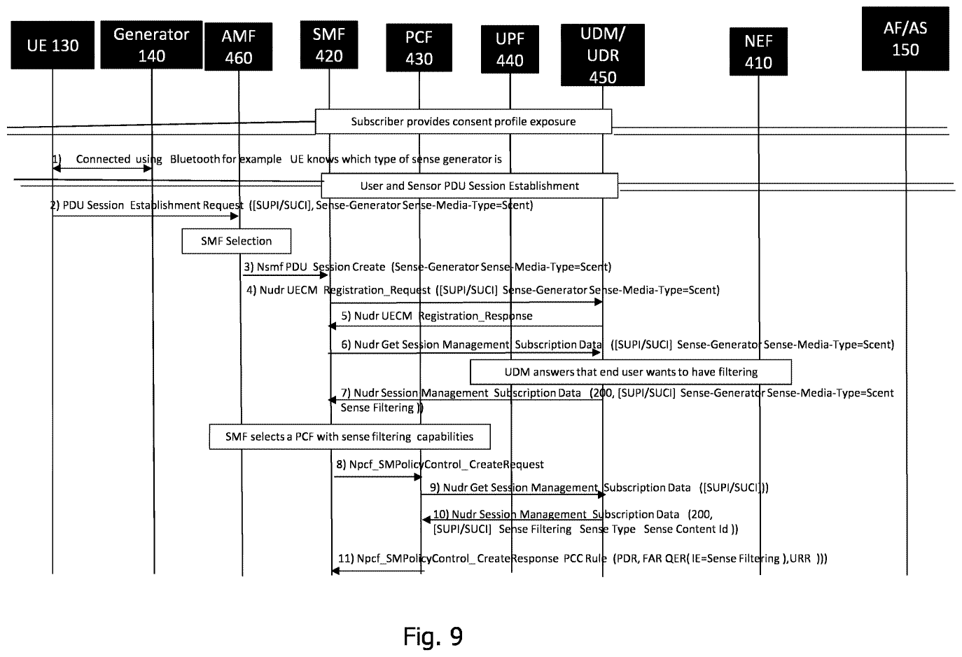

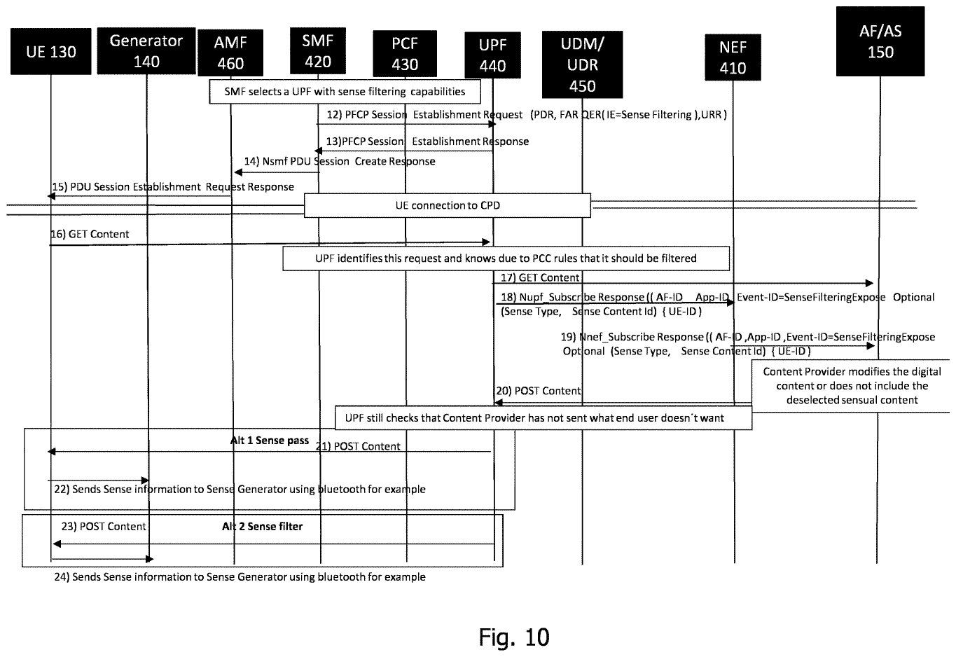

As has been explained above, the scenario of FIGS. 7 and 8 illustrates the case in which the subscriber has not given his or her consent to exposure of the filtering control information to third parties (such as a content provider). FIGS. 9 and 10 illustrate the case in which such consent has been given. This means that the filtering operation can then also take place in the CPD (see right-hand side of FIG. 3B). The signaling steps illustrated in FIGS. 9 and 10 are to a large extent identical to the steps discussed above with reference to FIGS. 7 and 8. For this reason, only the differing aspects will be described in greater detail.

Steps 1) to 16) of FIGS. 9 and 10 correspond to steps 1) to 16) of FIGS. 7 and 8, respectively. In step 17) in both scenarios, the AF 150 receives a GET Content message indicative of the UE 130 requesting digital content (see also step 332 of FIG. 3B). In deviation from the scenario of FIG. 8, in the scenario of FIG. 10 the UPF 440, after having identified the GET Content request send by the UE 130 in step 16), sends in step 18) an Nupf_Subscribe Response message to the NEF 410 with the Event-ID=SenseFilteringExpose. The NEF 410 forwards the corresponding information in step 19) to the AF 150 (see step 330 of FIG. 3B). After step 19), the AF 150 can decide to define, apply or take into account sense filtering according to the filtering control information defined for the UE 130.

The AF 150 will thus modify the requested digital content to be transmitted to the SD in step 20) to not include the deselected digital content, or it will not include the deselected sensual content into the digital content to be transmitted to the SD in step 20). In this way, the AF 150 filters out the deselected sensual content (see step 334 in FIG. 3B). In some variants, the UPF 440 may double-check that the deselected content is indeed not included in the digital content traffic and may either forward the digital content traffic without any modification to the UE 130 (see step 21)) or apply additional filtering operations in case a violation of the filtering control information is detected (see step 23)). The UE 130 will in each case forward the sensual content to the generator 140, see steps 22) and 24).

As has become apparent from the above description of exemplary realizations of the present disclosure, the technique presented herein allows MNOs to support the “Internet of Senses” in their 4G/5G-enabled networks. MNOs are enabled to specifically select core network capabilities (e.g., NFs such as PCFs and/or UPFs) that can best assist the implementation of non-A/V sensual content filtering. In some variants, the traffic load between the CND and the SD and, optionally, between the CPD and the CND can be reduced by the amount of the deselected sensual content.

Also, the user experience is enhanced by having a possibility to control sensual content transmission in a particularly granular manner. As a further option, the associated filtering control information can centrally be defined by a subscriber in the CND, rather than having to repeatedly perform this definition vis-à-vis each content provider. Moreover, content providers are enabled to define filtering policy information that controls the context in which their non-A/V sensual content is rendered in SDs.

1. A method of retrieving filtering control information from a subscriber database in a core network domain of a wireless communication network, the subscriber database storing subscription-related information, the method comprising:
receiving a first subscription data request, wherein the first subscription data request includes a first identifier associated with a subscription;
retrieving from the subscriber database in the core network domain, in response to the first subscription data request, filtering control information for the subscription associated with the first identifier, the filtering control information being indicative of sensual content different from audio and video content that has been deselected for transmission towards a subscriber domain; and
sending a first subscription data response including the filtering control information.

2. The method of claim 1, wherein the first identifier associated with the subscription identifies a terminal device that has requested or will be requesting digital content that is to be filtered in accordance with the filtering control information.

3. The method of claim 1, wherein at least the receiving, retrieving and sending steps are performed in the context of a digital content transmission session.

4. The method of claim 1, wherein at least one of the receiving, retrieving and sending steps is performed by one of a unified data repository, UDR, a unified data management, UDM, entity and a policy control function, PCF, of a 5^{th} Generation-, 5G-, enabled core network domain or by one of a subscriber profile repository, SPR, a home subscriber server, HSS, and a policy and charging rules function, PCRF, of a 4^{th} Generation-, 4G-, enabled core network domain.

5. The method of claim 4, wherein the first subscription data request is received by the UDR from the PCF, and wherein the first subscription data response is sent by the UDR to the PCF.

6. The method of claim 4, wherein the first subscription data request is received by the UDM entity from the PCF, and wherein the first subscription data response is sent by the UDM entity to the PCF.

7. The method of claim 1, further comprising:
receiving a second subscription data request preceding the first subscription data request, wherein the second subscription data request includes the first identifier;
retrieving from the subscriber database, in response to the second subscription data request, filtering status information for the subscription associated with the first identifier, wherein the filtering status information defines whether or not sensual content filtering is to be applied for the subscription; and
sending a second subscription data response including the filtering status information.

8. The method of claim 7, wherein at least one of the receiving, retrieving and sending steps is performed by one of a unified data repository, UDR, a unified data management, UDM, entity and a policy control function, PCF, of a 5^{th} Generation-, 5G-, enabled core network domain or by one of a subscriber profile repository, SPR, a home subscriber server, HSS, and a policy and charging rules function, PCRF, of a 4^{th} Generation-, 4G-, enabled core network domain, and wherein the second subscription data request is received by the UDM entity from a session management function, SMF, of the 5G-enabled core network domain, and wherein the second subscription data response is sent by the UDM entity to the SMF.

9. The method of claim 8, further comprising:
selecting, by the SMF and based on the filtering status information received in the second subscription data response, the PCF that is to send the first subscription data request to be a PCF that supports sensual content filtering.

10. The method of claim 8, further comprising:
receiving, by the SMF, the filtering control information from the PCF; and
selecting, by the SMF and based on the filtering control information received from the PCF, a user plane function, UPF, of the 5G-enabled core network domain that supports sensual content filtering.

11. The method of claim 1, further comprising:
receiving, from a terminal device in the subscriber domain, the filtering control information in the context of the first or a second identifier associated with the subscription; and
storing the subscriber filtering control information for the subscription associated with the first or the second identifier in the subscriber database.

12. The method of claim 11, wherein the filtering control information is received from the terminal device via one of a Web portal and an application running on the terminal device.

13. (canceled)

14. A method of filtering user plane traffic in a core network domain of a wireless communication network, the method comprising:
receiving filtering control information indicative of sensual content different from audio and video content that has been deselected for transmission towards a subscriber domain;
detecting user plane traffic that requires sensual content filtering, the user plane traffic originating in a content provider domain and is directed towards the subscriber domain; and
applying the filtering control information to the detected user plane traffic so as to filter out the deselected sensual content.

15. The method of claim 14, wherein the method is performed by one of a user plane function, UPF, of a 5^{th} Generation-, 5G-, enabled core network domain and a user plane packet date network gateway, PGW-U, of a 4^{th} Generation-, 4G-, enabled core network domain.

16.-30. (canceled)

31. An apparatus for retrieving filtering control information from a subscriber database in a core network domain of a wireless communication network, the subscriber database storing subscription-related information, the apparatus being configured to:
receive a first subscription data request, wherein the first subscription data request includes a first identifier associated with a subscription;
retrieve from the subscriber database in the core network domain, in response to the first subscription data request, filtering control information for the subscription associated with the first identifier, the filtering control information being indicative of sensual content different from audio and video content that has been deselected for transmission towards a subscriber domain; and
send a first subscription data response including the filtering control information.

32. (canceled)

33. An apparatus for filtering user plane traffic in a core network domain of a wireless communication network, the apparatus being configured to:
receive filtering control information indicative of sensual content different from audio and video content that has been deselected for transmission towards a subscriber domain;
detect user plane traffic that requires sensual content filtering, the user plane traffic originating in a content provider domain and is directed towards the subscriber domain; and
apply the filtering control information to the detected user plane traffic so as to filter out the deselected sensual content.

34.-41. (canceled)

42. The method of claim 2, wherein at least the receiving, retrieving and sending steps are performed in the context of a digital content transmission session.

43. The method of claim 2, wherein at least one of the receiving, retrieving and sending steps is performed by one of a unified data repository, UDR, a unified data management, UDM, entity and a policy control function, PCF, of a 5^{th} Generation-, 5G-, enabled core network domain or by one of a subscriber profile repository, SPR, a home subscriber server, HSS, and a policy and charging rules function, PCRF, of a 4^{th} Generation-, 4G-, enabled core network domain.

44. The method of claim 43, wherein the first subscription data request is received by the UDR from the PCF, and wherein the first subscription data response is sent by the UDR to the PCF.

45. The method of claim 43, wherein the first subscription data request is received by the UDM entity from the PCF, and wherein the first subscription data response is sent by the UDM entity to the PCF.
